(19) United States
(12) Patent Application Publication
(10) Pub. No.: US 2016/0260153 A1
(43) Pub. Date: Sep. 8, 2016

(54) METHOD AND SYSTEM FOR NON-MARKOV BASED PRODUCT RECOMMENDATION

(71) Applicant: MASTERCARD INTERNATIONAL INCORPORATED, Purchase, NY (US)

(72) Inventors: Jean-Pierre GERARD, Croton-On-Hudson, NY (US); Serge BERNARD, Danbury, CT (US); Rohit CHAUHAN, Somers, NY (US); Po HU, Norwalk, CT (US)

(73) Assignee: MASTERCARD INTERNATIONAL INCORPORATED, Purchase, NY (US)

(21) Appl. No.: 14/638,416

(22) Filed: Mar. 4, 2015

(51) Int. Cl. G06Q 30/06

(52) U.S. Cl. CPC G06Q 30/0631; G06Q 30/0635

(57) ABSTRACT

A method for identifying consumer purchase probability includes: storing transaction data entries, each entry including a transaction time, a consumer identifier, and a first product identifier or second product identifier; receiving transaction data for a specific consumer's transaction including a purchase time and the first product identifier; identifying a present time; calculating a ratio of consumers that have purchased the first and second products to consumers that have only purchased the first product; calculating, for consumer that have purchased both products, an average time interval based on a difference in the transaction time for purchase of the first product and transaction time for purchase of the second product; calculating a recency time based on time between the present time and the purchase time; and calculating a probability that the specific consumer will purchase the second product based on the calculated ratio of consumers, average time interval, and recency time.

### FIELD

The present disclosure relates to identifying probabilities for consumer purchases of a product, specifically using recency and time decay data for a general population of consumers to determine a probability that an individual consumer will purchase a specific product.

### BACKGROUND

Merchants, retailers, advertisers, content providers, and other entities are often interested in identifying as much information as they can about consumers and their shopping habits. Knowing what a consumer purchases and when can be valuable in identifying what a consumer may purchase next, with many entities attempting to influence the consumer to purchase a particular product or to purchase a product from a particular merchant. Consumer purchasing data is analyzed to identify habits, routines, and regular purchases made by the consumer. For example, if a consumer goes to a coffee shop every Wednesday morning, an advertiser may capitalize on that information by sending the consumer an ad for a new coffee shop just before they get their usual coffee.

However, such data and the conclusions reached via traditional analysis thereof can often be limiting. In many instances, a long history of a consumer's purchasing behavior may be necessary in order to provide worthwhile estimates of future action, which may be unavailable. Of course, taking into consideration actions from a relatively long time before may distort a view of a consumer's current interests. In addition, evaluating a consumer based on their own history without regard to the behavior of others may provide for an incomplete picture of their potential future actions. Furthermore, many existing systems for predicting consumer behavior make discrete predictions, without calculating probabilities, which can be a very useful metric for use by entities, such as advertisers.

Thus, there is a need for a technical solution to accurate calculate probabilities that a consumer will purchase a specific product based on not only the consumer's own purchase or purchase, but also the purchase of other consumers and additional metrics, such as the length of time between purchases by the other consumers and the target consumer's own previous purchase. Such data may provide a more complete picture of a consumer's purchase behavior and may provide valuable calculations that may be useful for merchants and other entities, while at the same time protecting consumer privacy by not utilizing any potentially sensitive consumer information.

### SUMMARY

The present disclosure provides a description of systems and methods for identifying probabilities that a consumer will purchase a product.

A method for identifying a probability that a consumer will purchase a product includes: storing, in a transaction database, a plurality of transaction data entries, wherein each transaction data entry includes data related to a payment transaction involving one of a plurality of consumers including at least a transaction time and/or date, a consumer identifier associated with the involved consumer, and one of: a first product iden tifier associated with a first product and a second product identifier associated with a second product; receiving, by a receiving device, transaction data for a payment transaction involving a specific consumer, wherein the transaction data includes a purchase time and/or date and the first product identifier; identifying, by a processing device, a present time; calculating, by the processing device, a ratio of consumers that have purchased the first product and the second product to consumers that have only purchased the first product based on the data included in the transaction data entries stored in the transaction database; calculating, for each consumer that has purchased the first product and the second product, an average time interval based on a difference in the transaction time and/or date included in a first transaction data entry including a consumer identifier associated with the respective consumer and the first product identifier and a second transaction data entry including the consumer identifier associated with the respective consumer and the second product identifier; calculating, by the processing device, a recency time based on a difference between the identified present time and the purchase time and/or date included in the received transaction data; and calculating, by the processing device, a probability that the specific consumer will purchase the second product based on at least the calculated ratio of consumers, the calculated average time interval, and the calculated recency time.

A system for identifying a probability that a consumer will purchase a product includes a transaction database, a receiving device, and a processing device. The transaction database is configured to store a plurality of transaction data entries, wherein each transaction data entry includes data related to a payment transaction involving one of a plurality of consumers including at least a transaction time and/or date, a consumer identifier associated with the involved consumer, and one of: a first product identifier associated with a first product and a second product identifier associated with a second product. The receiving device is configured to receive transaction data for a payment transaction involving a specific consumer, wherein the transaction data includes a purchase time and/or date and the first product identifier. The processing device is configured to: identify a present time; calculate a ratio of consumers that have purchased the first product and the second product to consumers that have only purchased the first product based on the data included in the transaction data entries stored in the transaction database; calculate, for each consumer that has purchased the first product and the second product, an average time interval based on a difference in the transaction time and/or date included in a first transaction data entry including a consumer identifier associated with the respective consumer and the first product identifier and a second transaction data entry including the consumer identifier associated with the respective consumer and the second product identifier; calculate, by the processing device, a recency time based on a difference between the identified present time and the purchase time and/or date included in the received transaction data; and calculate a probability that the specific consumer will purchase the second product based on at least the calculated ratio of consumers, the calculated average time interval, and the calculated recency time.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for identifying consumer probability of purchasing a product in accordance with exemplary embodiments.

FIG. 2 is a block diagram illustrating the processing server of FIG. 1 for the identification of consumer purchase probabilities in accordance with exemplary embodiments.

FIG. 3 is a flow diagram illustrating a process for identifying product recommendations using non-Markov based calculations using the processing server of FIG. 2 in accordance with exemplary embodiments.

FIG. 4 is a flow diagram illustrating a process for identifying a recommended product based on purchase probabilities in accordance with exemplary embodiments.

FIG. 5 is a flow diagram illustrating a process for identifying recommended consumers based on purchase probabilities in accordance with exemplary embodiments.

FIG. 6 is a flow chart illustrating an exemplary method for identifying a probability that a consumer will purchase a product in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal, etc.

### System for Identifying Consumer Purchase Probabilities

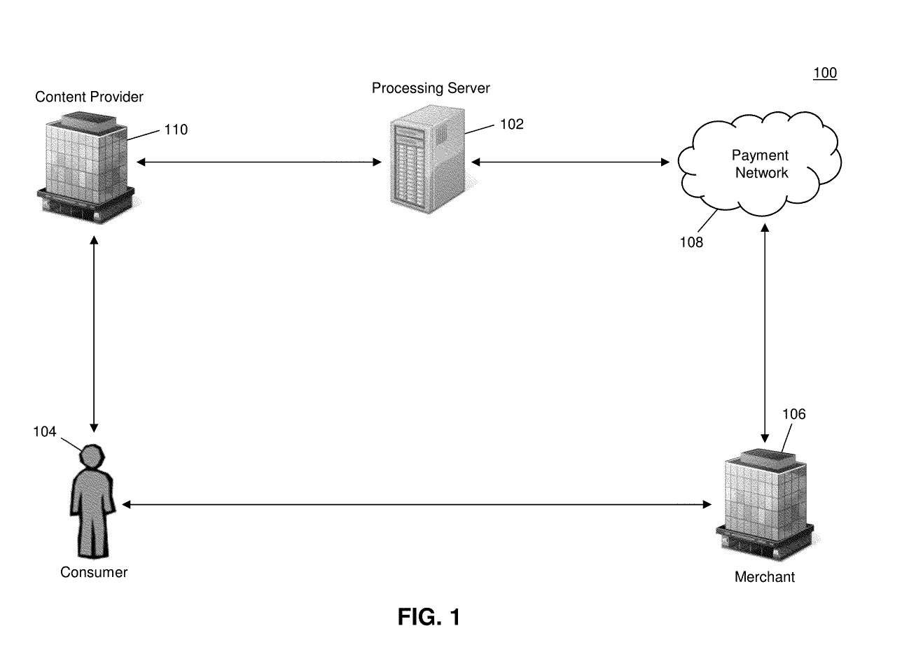

FIG. 1 illustrates a system 100 for identifying probabilities that a consumer will purchase a product based on other consumer purchases an additional transaction metrics.

The system 100 may include a processing server 102. The processing server 102, discussed in more detail below, may be configured to calculate probabilities that a consumer will purchase a particular product. The processing server 102 may collect transaction data for a plurality of payment transactions between consumers 104 and merchants 106. The transaction data may be collected from one or more payment networks 108 configured to process the payment transactions, which may collect the transaction data and provide it to the processing server 102. In some embodiments, the processing server 102 may be a part of the payment network 108, and, in some instances, may be configured to process payment transactions.

The transaction data for the payment transactions involving the consumers 104 and merchants 106 may include any data suitable for performing the functions disclosed herein, such as transaction times and/or dates. In some embodiments, the transaction data may also include product data, which may identify one or more goods or services purchased as a result of the corresponding payment transaction. For instance, the transaction data may include a universal product code, product identifier, stock-keeping unit, International Standard Book Number, European article number, manufacturer part number, etc.

In order to calculate the probability that a given consumer 104 will purchase a specific product, the processing server 102 may first identify all of the consumers 104 that have previously purchased the specific product using the transaction data. The processing server 102 may then identify a prior product that each of the identified consumers 104 also purchased. The prior product may be related to the specific product (e.g., by manufacturer, category, industry, price, etc.), or may be unrelated to the specific product. The prior product may be, for example, identified as a product purchased by a plurality of the identified consumers 104, such as a majority of the consumers 104.

In some instances, the prior product may be identified by a content provider 110. The content provider 110 may be a merchant 106, an advertiser, a manufacturer, an offer provider, or other suitable entity that may be interested in probabilities of consumers 104 who purchased the prior product to purchase the specific product or in the identification of consumers 104 that may have a high probability to purchase the specific product. The content provider 110 may, for example, identify a potential specific product for that they may wish to advertise to a consumer 104 that has purchased a specific prior product. The content provider 110 may then notify the processing server 102 of the products in a data request to request a probability that a consumer 104 will purchase the specific product.

Once the processing server 102 has identified consumers 104 that have purchased both the prior product and the specific product, the processing server 102 may calculate time intervals between the purchase of the prior product and the purchase of the specific product for each of the consumers 104. The processing server 102 may also identify a ratio of the consumers 104 that did not go on to purchase the specific product after previously purchasing the prior product. The processing server 102 may then use the calculated time intervals and ratio in combination with the amount of time that has passed since the particular consumer 104 has purchased the prior product to calculate a probability that the consumer 104 will purchase the specific product, as discussed in more detail below.

In some embodiments, the probability may be indicative of the probability that the consumer 104 will purchase the specific product at the present time. In other embodiments, the processing server 102 may calculate a probability that the consumer 104 will purchase the specific product at one or more future times, such as in the following week. The processing server 102 may also be configured to identify a plurality of consumers 104 that have a specific probability to purchase the specific product. For example, the processing server 102 may identify those consumers 104 that purchased the prior product and not the specific product, and may calculate the probability for each one to purchase the specific product, based on their respective time intervals. The processing server 102 may then recommend consumers 104 to the content provider 110 whose probability exceeds a predetermined value, such as one provided by the content provider 110.

By calculating probabilities using time intervals, purchasing ratios, and time decay, the processing server 102 may be able to provide an accurate probability for the purchase of a specific product by a consumer 104 at any given time. In addition, by comparing the purchasing metrics with those of other, general consumers 104, rather than relying on a specific consumer's past transaction history, the processing server 102 may be able to provide accurate probabilities without obtaining a significant transaction history for any given consumer. In some instances, the processing server 102 may be able to calculate probabilities with possessing only one or two transactions (e.g., corresponding to the prior and specific products) for each consumer 104. In such an instance, the processing server 102 may be able to perform the calculations and determinations herein using a significantly smaller amount of data than traditional methods, which may also be more widely available to entities, such as the content provider 110, than the information necessary to predict consumer purchase behavior in traditional methods.

In addition, because the processing server 102 does not need to utilize specific consumer data or length consumer transaction history, and does not need to identify specific details about a particular consumer 104 or related consumers, the processing server 102 may preserve consumer privacy and security at a higher level than traditional systems. The identification of a consumer 104 as one having purchased a particular product, when taken in combination with a plurality of others consumers that have purchased the same product, may be such that the processing server 102 may not possess any information that may be personally identifiable to a consumer 104. As a result, the methods and systems discussed herein may be more advantageous for consumers 104 themselves, as their privacy may be secured, as well as to content providers 110 and other entities, who may receive valuable purchasing probabilities without compromising consumer privacy, which may strengthen their relationships with consumers.

### Processing Server

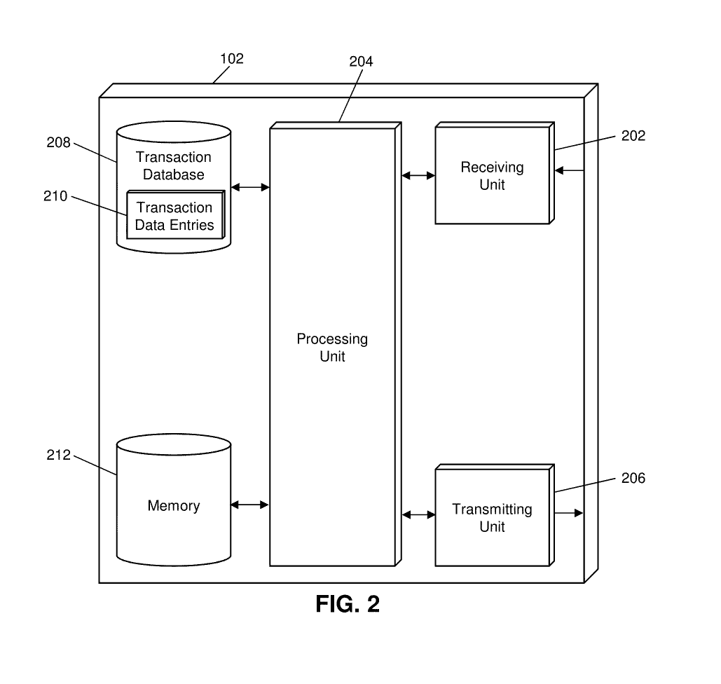

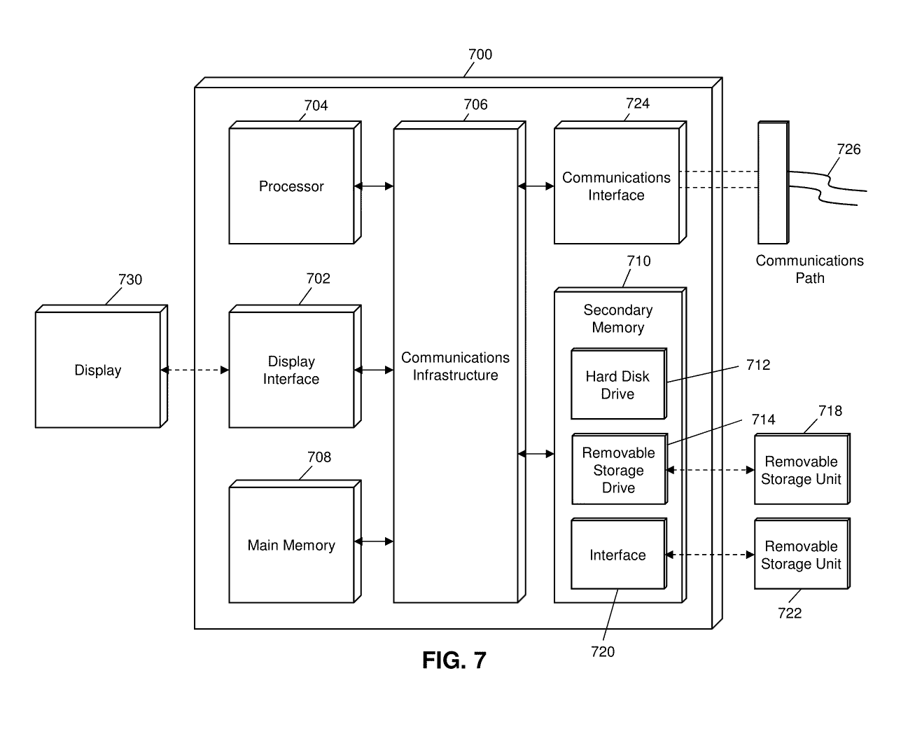

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive transaction data from the payment network 108, from merchants 106, from financial institutions (e.g., acquiring banks associated with merchants 106 or issuing banks associated with consumers 104), or any other suitable source. The transaction data may be stored in a transaction database 208, also included in the processing server 102.

The transaction database 208 may include a plurality of transaction data entries 210. Each transaction data entry 210 may include data related to a payment transaction involving one of a plurality of consumers 104 including at least a consumer identifier associated with the involved consumer 104, a transaction time and/or date, and a product identifier. The consumer identifier may be a unique value associated with a consumer 104, such as a transaction account number, reference number, identification number, username, e-mail address, phone number, tax identification number, etc. The product identifier may be a unique value associated with a product purchased in the corresponding payment transaction, and may be one of a prior (e.g., first) product or a specified (e.g., second or target) product.

The receiving unit 202 may be further configured to receive a first product identifier. The first product identifier may be received from a content provider 110 or other entity, or may be input into the processing server 102 by an operator of the processing server 102. In such an instance, the receiving unit 202 may receive data via one or more input devices, and/or the processing server 102 may include a separate input unit configured to interface with one or more input devices, such as a mouse, keyboard, touch screen, camera, microphone, etc. In some instances, the receiving unit 202 may also receive a second product identifier and/or a consumer product identifier, which may accompany a request for data.

The processing server 102 may further include a processing unit 204. The processing unit 204 may be configured to perform the functions of the processing server 102 as discussed herein that will be apparent to persons having skill in the relevant art. The processing server 102 may be configured to identify transaction data entries 210 in the transaction database 208 that include a product identifier corresponding to a first product identifier, referred to herein as a first set of transaction data entries 210. The processing server 102 may be further configured to perform calculations based on the transaction data entries 210 included in the transaction database 208 to calculate probabilities that consumers 104 will purchase a given product. It will be apparent to persons having skill in the relevant art that the additional (e.g., in addition to transaction data entries 210 that include the first product identifier) transaction data entries 210 may be dependent on the data being requested.

For example, if a data request is for the probability that a specific consumer 104 will purchase a specific second product, then the processing unit 204 may identify the transaction data entries 210 that include a consumer identifier included in a transaction data entry 210 in the first set that also include the second product identifier. In another example, if the data request is for consumers that have a high probability of purchasing the second product, then the processing unit 204 may identify the transaction data entries 210 that include a consumer identifier included in a transaction data entry 210 in the first set that also include the second product identifier, as well as those transaction data entries 210 in the first set that do not have a corresponding transaction data entry 210 including the same consumer identifier that also includes the second product identifier. In yet another example, if a data request is for products that a specific consumer has a high probability of purchasing, then the processing unit 204 may identify multiple second sets of transaction data entries 210 for a plurality of product identifiers that are included in transaction data entries 210 having consumer identifiers included in the transaction data entries 210 in the first set.

Once a first and second set of transaction data entries 210 have been identified, the processing unit 204 may be configured to calculate probabilities. Calculation of probabilities may include calculating a ratio of consumers that have purchased the first product as well as a second product (e.g., as specified or as being tested by the processing unit 204 for probability calculation depending on the data request) compared to consumers that have only purchased the first product; calculation of an average time interval between purchase of the first product and purchase of the second product for those consumers that did purchase the second product, and calculation of a recency time, representative of time that has elapsed since the specific consumer 104 has purchased the first product.

Once the calculations have been performed, the processing unit 204 may calculate a probability that the specific consumer 104 will purchase the second product based on the ratio of consumers, the average time interval, and the recency time. In some embodiments, the processing unit 204 may also calculate the probability based on one or more of: out-of-domain variables that will be apparent to persons having skill in the relevant art, a purchase frequency (e.g., calculated by the processing unit 204 based on frequency of the first product identifier in the transaction data entries 210), or other suitable variable that will be apparent to persons having skill in the relevant art.

In some embodiments, the processing unit 204 may be further configured to perform one or more functions based on the calculated probabilities. For instance, if a data request is for consumers having at least a specific probability, the processing unit 204 may filter out consumers for whom the probability to purchase the second product is below a threshold. In another example, the processing unit 204 may calculate the probability that a consumer 104 will purchase a second product from a group of second products, and may identify a specific product for recommendation based on the probabilities calculated thereof.

The processing server 102 may also include a transmitting unit 206. The transmitting unit 206 may be configured to transmit data over one or more networks via one or more network protocols. The transmitting unit 206 may be configured to transmit calculations and conclusions made by the processing unit 204, such as probabilities, product recommendations, identified consumers, etc., to one or more entities, such as the content provider 110, merchant 106, etc. In some instances, the data transmitted by the transmitting unit 206 may be transmitted in response to a data request received by the receiving unit 202.

The processing server 102 may also include a memory 212. The memory 212 may be configured to store data suitable for performing the functions of the processing server 102 as discussed herein. For example, the memory 212 may include one or more rules or algorithms for performing the calculations discussed herein, for identifying products, for making recommendations, etc. Additional data that may be stored in the memory 212 will be apparent to persons having skill in the relevant art.

It will also be apparent to persons having skill in the relevant art that, in some embodiments, the processing server 102 may include additional components and/or that the components of the processing server 102 illustrated in FIG. 2 and discussed herein may be configured to perform additional functions. For instance, in embodiments where the processing server 102 may be a part of the payment network 108, the components of the processing server 102 may be further configured to perform functions for the processing of payment transactions, such as the receipt and transmission of transaction messages, calculation of fraud scores, application of account controls to transactions, etc.

### Process for Identifying Recommended Products

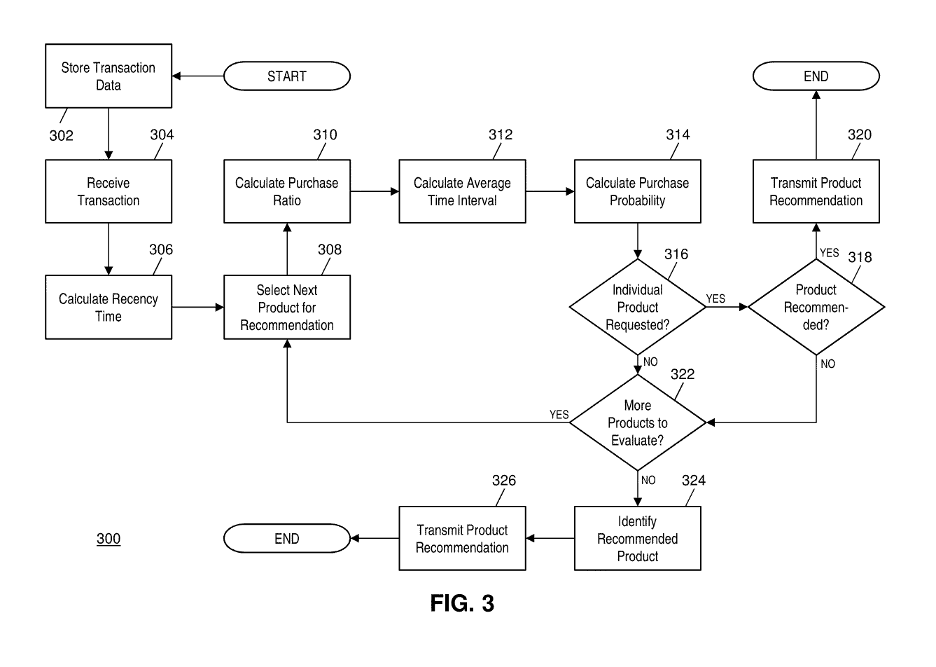

FIG. 3 illustrates a process 300 for the recommendation of products to a consumer 104 by the processing server 102 using the methods and systems discussed herein.

In step 302, the processing unit 204 of the processing server 102 may store transaction data in the transaction database 208 of the processing server 102 as a plurality of transaction data entries 210. Each transaction data entry 210 may include at least a consumer identifier associated with one of a plurality of consumers 104, a product identifier corresponding to a product purchased in the related payment transaction, and a transaction time and/or date. In step 304, the receiving unit 202 may receive transaction data for a payment transaction involving a specific consumer 104 that includes a first product identifier and a transaction time and/or date. In some embodiments, step 304 may include the identification of the transaction in the transaction database 208, such as based on a request received via the receiving unit 202.

In step 306, the processing unit 204 may calculate a recency time. The recency time may be based on a time elapsed to a present time from the transaction time and/or date included in the identified transaction. In step 308, the processing unit 204 may select a second product for evaluation for a recommendation. In some embodiments, the second product may be identified via a request received from the receiving unit 202, such as from the content provider 110. In other embodiments, the second product may be identified by the processing unit 204, such as via rules and/or algorithms for identifying products for recommendation testing, such as stored in the memory 212.

In step 310, the processing unit 204 may calculate a purchase ratio, which may be the ratio of consumers 104 that purchased both the first product and the selected second product to consumers 104 that purchased only the first product. In step 312, the processing unit 204 may calculate an average time interval, which may be an average of the time interval between purchase of the first product to purchase of the second product to those consumers 104 that have purchased both products. In step 314, the processing unit 204 may calculate the probability that the consumer 104 will purchase the selected second product based on the calculated recency time, purchase ratio, and average time interval.

In step 316, the processing unit 204 may identify if the selected second product is an individual product that had been requested. For example, if, in step 308, the second product was selected based on a data request from a content provider 110 for calculation of a probability a specific consumer 104 would buy that particular product, then the result of the determination in step 316 would be “yes.” If the processing unit 204 determines that the selected second product was the individual product evaluation requested, then, in step 318, the processing unit 204 may determine if that product is to be recommended. The determination may be based on the calculated probability, which may be compared to a threshold for recommendation. In some instances, the threshold may be identified by the processing unit 204, in other instances, the threshold may be identified in a data request received by the receiving unit 202.

If the product is to be recommended, then, in step 320, the transmitting unit 206 may transmit a product recommendation, such as to the content provider 110, directly to the consumer 104, etc. If the product is not to be recommended, or, in step 316, the processing unit 204 determined that the selected second product was not an individual product requested, then, in step 322, the processing unit 204 may determine if there are more products to evaluate for the consumer 104. The determination may be based on a receive data request, a selection of products identified by the processing unit 204 for testing, the calculated probability for the selected second product (e.g., the processing unit 204 may be configured to stop evaluating products once a first suitable one, such as one having at least a specific probability, has been identified), etc. If there are more products to evaluate, the process may return to step 308 where the next product to evaluate may be identified.

If there are no more products to evaluate, then, in step 324, the processing unit 204 may identify a recommended product. The recommended product may be based on the calculated probabilities for each selected product calculated via steps 308 to 314 of the process 300. For example, the processing unit 204 may identify the second product having the highest probability for purchase by the consumer 104. In some instances, the processing unit 204 may identify that no product is to be recommended to the consumer 104, such as if the probability for each product is below a specific threshold. In step 326, the transmitting unit 206 may transmit a product recommendation to the content provider 110 or suitable entity, which may be identify one or more products that are recommended, or if no product is recommended, based on the identification made in step 324.

### Identification of a Recommended Product

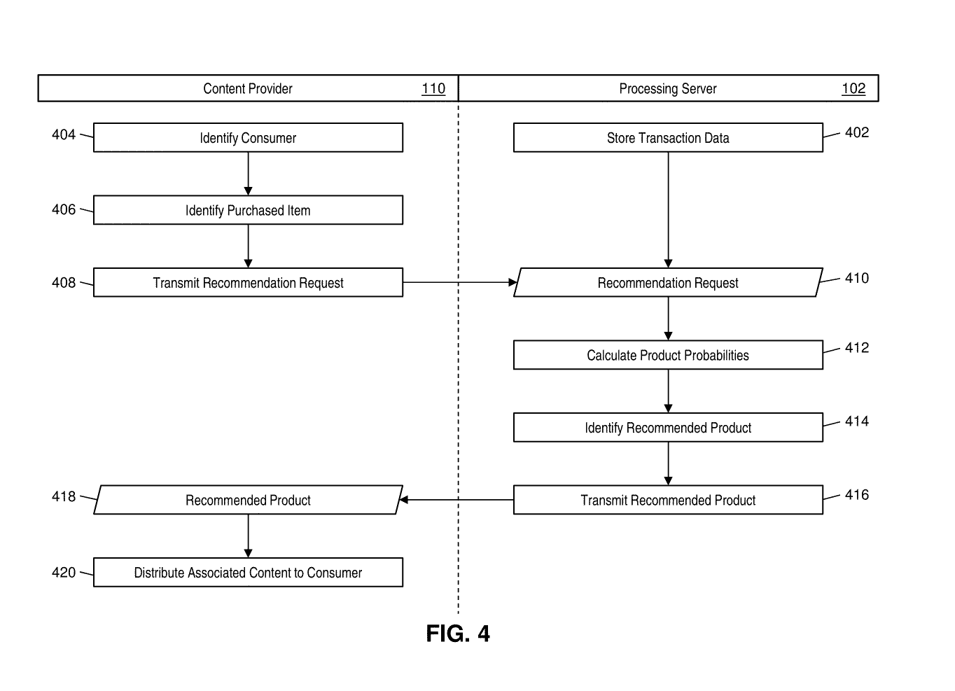

FIG. 4 illustrates a process for the identification of a recommended product for a consumer 104 from a plurality of requested products using the system 100.

In step 402, the processing server 102 may store transaction data entries 210 in the transaction database 208. Each of the transaction data entries 210 may include data related to a payment transaction including a consumer identifier, a transaction time and/or date, and one of a plurality of product identifiers. In step 404, the content provider 110 may identify a consumer 104 for which they would like a product recommendation. In step 406, the content provider 110 may identify a first product that had been purchased by the consumer 104. In step 408, the content provider 110 may transmit a recommendation request to the processing server 102.

In step 410, the receiving unit 202 of the processing server 102 may receive the recommendation request. The recommendation request may include at least the consumer identifier associated with the identified consumer 104 and a product identifier associated with the first product. In some embodiments, the recommendation request may also include a plurality of second product identifiers, such as associated with products that the content provider 110 may wish to advertise to the identified consumer 104.

In step 412, the processing unit 204 of the processing server 102 may calculate product probabilities for each of the plurality of second products, such as by using the processes illustrated in the process 300 in FIG. 3 and discussed above. In instance where the recommendation request does not include second product identifiers, the second products for which product probabilities are calculated may be identified by the processing unit 204, such as based on rules and/or algorithms included in the memory 212. In step 414, the processing unit 204 may identify the recommended product. The recommended product may be identified based on the calculated probabilities, such as the product having the highest calculated probability.

In step 416, the transmitting unit 206 of the processing server 102 may transmit the recommendation to the content provider 110 in response to the received recommendation request. In step 418, the content provider 110 may receive the product recommendation that identifies the recommended second product. In step 420, the content provider 110 may distribute content associated with the recommended product to the identified consumer 104.

### Identification of Recommended Consumers

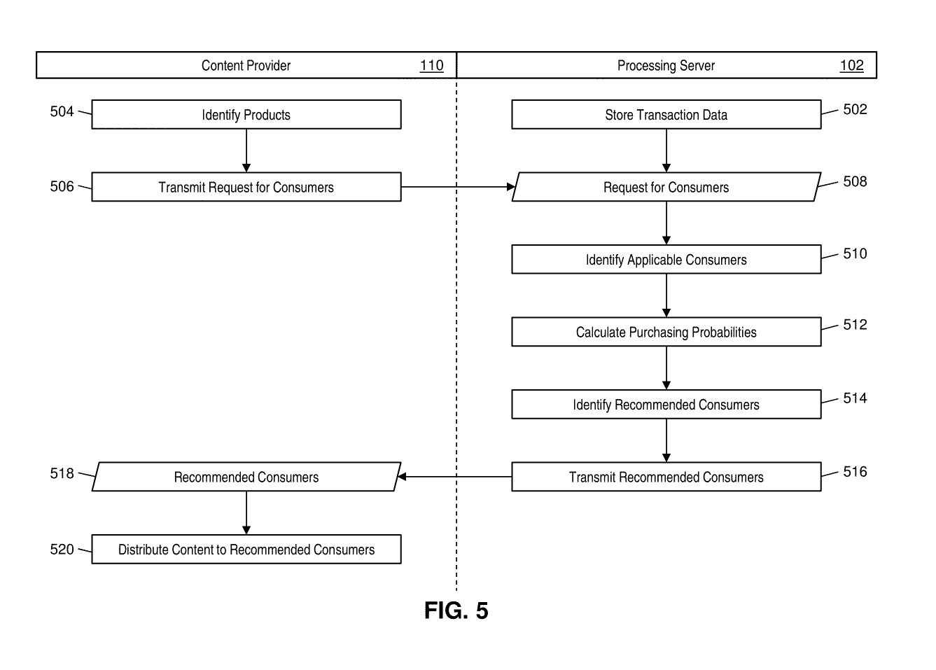

FIG. 5 illustrates a process for identifying consumers 104 for recommendation of a second product using the system 100.

In step 502, the processing server 102 may store transaction data entries 210 in the transaction database 208. Each of the transaction data entries 210 may include data related to a payment transaction including a consumer identifier, a transaction time and/or date, and one of a plurality of product identifiers. In step 504, the content provider 110 may identify a first product purchased by consumers 104 as well as a second product that they would like to recommend to consumers 104 that purchased the first product. In step 506, the content provider 110 may transmit a request for consumers to the processing server 102.

In step 508, the receiving unit 202 of the processing server 102 may receive the request for consumers. The request for consumers may include at least the first product identifier and the second product identifier. In some embodiments, the request for consumers may also include consumer identifiers associated with a plurality of consumers 104 identified by the content provider 110, such as those to which the content provider 110 may be able to advertise. In step 510, the processing unit 204 of the processing server 102 may identify applicable consumers. The identification of applicable consumers may include identifying consumers from those provided by the content provider 110 for whom transaction data is available, or the identification of all consumers that have purchased the first product based on the transaction data entries 210 in the transaction database 208.

In step 512, the processing unit 204 may calculate purchase probabilities for each of the applicable consumers to purchase the second product, using the methods and systems discussed herein, such as illustrated in the process 300 illustrated in FIG. 3 and discussed above. In step 514, the processing unit 204 may identify recommended consumers from the applicable consumers. The recommended consumers may be consumers whose corresponding probability is above a predetermined value, which may be set by the processing server 102 and/or the content provider 110 (e.g., specified in the request for consumers).

In step 516, the transmitting unit 206 of the processing server 102 may transmit the recommendation of consumers to the content provider 110, which may receive the recommendation in step 518. In step 520, the content provider 110 may distribute content (e.g., advertisements, offers, etc.) associated with the second product to the consumers 104 recommended by the processing server 102.

### Exemplary Method for Identifying Consumer Purchase Probabilities

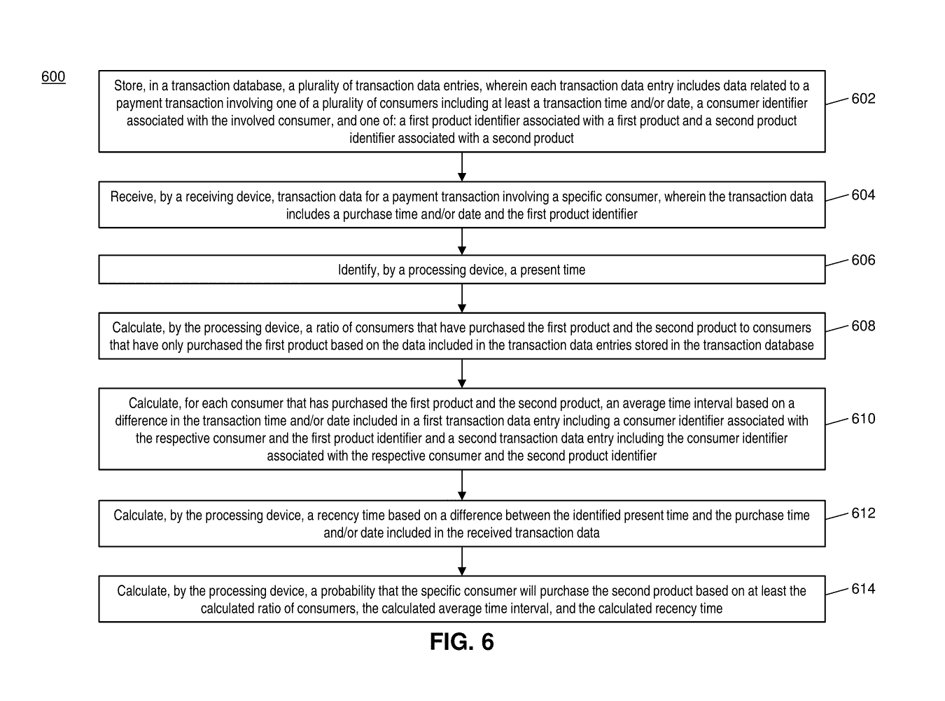

FIG. 6 illustrates a method 600 for the identification of a probability that a consumer will purchase a product based on consumer purchase behaviors and time decay.

In step 602, a plurality of transaction data entries (e.g., transaction data entries 210) may be stored in a transaction database (e.g., the transaction database 208), wherein each transaction data entry 210 includes data related to a payment transaction involving one of a plurality of consumers (e.g., consumers 104) including at least a transaction time and/or date, a consumer identifier associated with the involved consumer 104, and one of: a first product identifier associated with a first product and a second identifier associated with a second product. In step 604, transaction data for a payment transaction involving a specific consumer 104 may be received by a receiving device (e.g., the receiving unit 202), wherein the transaction data includes a purchase time and/or date and the first product identifier.

In step 606, a processing device (e.g., the processing unit 204) may identify a present time. In step 608, a ratio of consumers may be calculated by the processing device 204, wherein the ratio of consumers is a ratio of consumers that have purchased the first product and the second product to consumers that have only purchased the first product based on the data included in the transaction data entries 210 stored in the transaction database 208. In step 610, an average time interval may be calculated for each consumer 104 that has purchased the first product and the second product based on a difference in transaction time and/or date included in a first transaction data entry 210 including a consumer identifier associated with the respective consumer 104 and the first product identifier and a second transaction data entry 210 including the consumer identifier associated with the respective consumer 104 and the second product identifier.

In step 612, a recency time may be calculated by the processing device 204 based on a difference between the identified present time and the purchase time and/or date included in the received transaction data. In step 614, a probability may be calculated by the processing device 204 that the specific consumer 104 will purchase the second product based on at least the calculated ratio of consumers, the calculated average time interval, and the calculated recency time.

In one embodiment, the method 600 may further include transmitting, by a transmitting device (e.g., the transmitting unit 206), the calculated probability. In some embodiments, the method 600 may also include calculating, by the processing device 204, a purchase frequency based on a frequency of transaction data entries 210 of the plurality of transaction data entries that include the first product identifier, wherein the probability is further based on the calculated purchase frequency.

In one embodiment, the method 600 may further include storing, in a memory (e.g., the memory 212), one or more out-of-domain variables associated with the first product, wherein the probability is further based on the stored one or more out-of-domain variables. In some embodiments, the method 600 may also include: identifying, by the processing device 204, a recommendation associated with the second product based on the calculated probability; and transmitting, by the transmitting device 206, the identified recommendation.

In one embodiment, each transaction data entry 210 may include one of: the first product identifier, the second product identifier, and a third product identifier associated with a third product. In a further embodiment, the method 600 may further include: repeating each of the calculating steps with the third product identifier in place of the second product identifier; and identifying, by the processing device 204, a recommendation, wherein the recommendation recommends one of the second product and the third product based on the calculated probability that the specific consumer 104 will purchase the second product and the calculated probability that the specific consumer 104 will purchase the third product. In an even further embodiment, the method 600 may even further include transmitting, by the transmitting device 206, the identified recommendation.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for identifying purchase probabilities for products.

While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying a probability that a consumer will purchase a product, comprising:
storing, in a transaction database, a plurality of transaction data entries, wherein each transaction data entry includes data related to a payment transaction involving one of a plurality of consumers including at least a transaction time and/or date, a consumer identifier associated with the involved consumer, and one of: a first product identifier associated with a first product and a second product identifier associated with a second product;
receiving, by a receiving device, transaction data for a payment transaction involving a specific consumer, wherein the transaction data includes a purchase time and/or date and the first product identifier;
identifying, by a processing device, a present time;
calculating, by the processing device, a ratio of consumers that have purchased the first product and the second product to consumers that have only purchased the first product based on the data included in the transaction data entries stored in the transaction database;
calculating, for each consumer that has purchased the first product and the second product, an average time interval based on a difference in the transaction time and/or date included in a first transaction data entry including a consumer identifier associated with the respective consumer and the first product identifier and a second transaction data entry including the consumer identifier associated with the respective consumer and the second product identifier;
calculating, by the processing device, a recency time based on a difference between the identified present time and the purchase time and/or date included in the received transaction data; and
calculating, by the processing device, a probability that the specific consumer will purchase the second product based on at least the calculated ratio of consumers, the calculated average time interval, and the calculated recency time.

2. The method of claim 1, further comprising:
transmitting, by a transmitting device, the calculated probability.

3. The method of claim 1, further comprising:
calculating, by the processing device, a purchase frequency based on a frequency of transaction data entries of the plurality of transaction data entries that include the first product identifier, wherein
the probability is further based on the calculated purchase frequency.

4. The method of claim 1, further comprising:
storing, in a memory, one or more out-of-domain variables associated with the first product, wherein
the probability is further based on the stored one or more out-of-domain variables.

5. The method of claim 1, further comprising:
identifying, by the processing device, a recommendation associated with the second product based on the calculated probability; and
transmitting, by a transmitting device, the identified recommendation.

6. The method of claim 1, wherein each transaction data entry includes one of: the first product identifier, the second product identifier, and a third product identifier associated with a third product.

7. The method of claim 6, further comprising:
repeating each of the calculating steps with the third product identifier in place of the second product identifier; and
identifying, by the processing device, a recommendation, wherein the recommendation recommends one of the second product and the third product based on the calculated probability that the specific consumer will purchase the second product and the calculated probability that the specific consumer will purchase the third product.

8. The method of claim 7, further comprising:
transmitting, by a transmitting device, the identified recommendation.

9. A system for identifying a probability that a consumer will purchase a product, comprising:
a transaction database configured to store a plurality of transaction data entries, wherein each transaction data entry includes data related to a payment transaction involving one of a plurality of consumers including at least a transaction time and/or date, a consumer identifier associated with the involved consumer, and one of: a first product identifier associated with a first product and a second product identifier associated with a second product;
a receiving device configured to receive transaction data for a payment transaction involving a specific consumer, wherein the transaction data includes a purchase time and/or date and the first product identifier; and
a processing device configured to
identify a present time,
calculate a ratio of consumers that have purchased the first product and the second product to consumers that have only purchased the first product based on the data included in the transaction data entries stored in the transaction database,
calculate, for each consumer that has purchased the first product and the second product, an average time interval based on a difference in the transaction time and/or date included in a first transaction data entry including a consumer identifier associated with the respective consumer and the first product identifier and a second transaction data entry including the consumer identifier associated with the respective consumer and the second product identifier,
calculate, by the processing device, a recency time based on a difference between the identified present time and the purchase time and/or date included in the received transaction data, and
calculate a probability that the specific consumer will purchase the second product based on at least the calculated ratio of consumers, the calculated average time interval, and the calculated recency time.

10. The system of claim 9, further comprising:
a transmitting device configured to transmit the calculated probability.

11. The system of claim 9, wherein
the processing device is further configured to calculate a purchase frequency based on a frequency of transaction data entries of the plurality of transaction data entries that include the first product identifier, and
the probability is further based on the calculated purchase frequency.

12. The system of claim 9, further comprising:
a memory configured to store one or more out-of-domain variables associated with the first product, wherein
the probability is further based on the stored one or more out-of-domain variables.

13. The system of claim 9, further comprising:
a transmitting device, wherein
the processing device is further configured to transmit a recommendation associated with the second product based on the calculated probability, and the transmitting device is configured to transmit the identified recommendation.

14. The system of claim 9, wherein each transaction data entry includes one of: the first product identifier, the second product identifier, and a third product identifier associated with a third product.

15. The system of claim 14, wherein the processing device is further configured to
repeat each of the calculating steps with the third product identifier in place of the second product identifier, and
identify a recommendation, wherein the recommendation recommends one of the second product and the third product based on the calculated probability that the specific consumer will purchase the second product and the calculated probability that the specific consumer will purchase the third product.

16. The system of claim 15, further comprising:
a transmitting device configured to transmit the identified recommendation.
